(19) United States
(12) Patent Application Publication
(10) Pub. No.: US 2003/0137609 A1
(43) Pub. Date: Jul. 24, 2003

(54) Multimedia system using plasma or liquid crystal display, display system of portable computer, and signal receiver for television, radio, and cellular telephone

(76) Inventor: Toshio Hayakawa, Los Angeles, CA (US)

Correspondence Address: Toshio Hayakawa, 10021 Tabor Street #311, Los Angeles, CA, 90034, US

(21) Appl. No.: 10/357,552

(22) Filed: Feb. 4, 2003

Related U.S. Application Data
(63) Continuation-in-part of application No. 10/100,643, filed on Mar. 19, 2002.
(60) Provisional application No. 60/345,926, filed on Dec. 31, 2001.

(51) Int. Cl. H04N 5/66; H04N 5/46; H04N 5/445

(52) U.S. Cl. 348/739; 348/552; 348/729; 725/59

(57) ABSTRACT

A flat panel multimedia display system (210), detachable or non-detachable type, of a multimedia portable computer (60), plasma or liquid crystal multimedia display system (300), a multimedia cellular telephone (40), and multimedia receiver system (200) are used to display video and audio multimedia information generated for televisions, digital radio, cellular telephone systems, portable computers, and all other multimedia devices. By connecting the newly invented multimedia receiver system (200) to the display system (210) of the multimedia portable computer system (60), and plasma or liquid crystal multimedia display system (300), a user can watch television programs, listen to radio, or browse Internet at any time and at any locations.

### CROSS REFERENCE TO RELATED APPLICATIONS

This application is based on and is a continuation-in-part of my co-pending U.S. utility patent application Ser. No. 10/100,643, filed Mar. 19, 2002, for Multimedia Display System Using Display Unit of Portable Computer, and Signal Receiver for Television, Radio, and Cellular Telephone, and which is, in turn, based on a U.S. provisional patent application Ser. No. 60/345,926 filed on Dec. 31, 2001.

### BACKGROUND

1. Field of Invention

This invention relates to a multimedia entertainment system using a liquid crystal display of a portable computer system, and to the multimedia entertainment system for using camera-mounted with sound recording or playback function cellular telephones and stand-alone plasma or liquid crystal display or alike.

2. Other References

“Display Technologies” by Patrick Dunn of Dell Corporation, July 1999. Published by Dell Corporation.

“Basic Television and Video Systems Sixth Edition” by Grob Herndon Glencoe. Published by McGraw-Hill

“HDTV High-Definition Television” by Stan Prentiss. Published by TAB BOOKS Inc.

“Practical ANTENNA Handbook Second Edition” by Joseph J. Carr. Published by TAB BOOKS Inc.

“Guide to Satellite Technology” by John A. Ross. Published by Prompt Publication

“The Radio Station, Second Edition” by Michael C. Keith/Joseph M. Published by Focal Press.

“Microwaves and Wireless Simplified” by Thomas S. Laverghetta. Published by Artech House.

“Microwave Engineering and Systems Application” by Edward A. Wolf/Roger Kaul. Published by John Wiley & Sons

3. Description of Prior Art

A portable computer having an active-matrix liquid-crystal display (AMLCD) is very popular according to the white paper written by Patrick Dunn of Dell Corporation, which is available on the web site of Dell Corporation. The processing power of CPU in a portable computer is also getting higher and higher in each year as Intel and AMD corporation races each other to come up with faster and better CPU by squeezing more transistors in limited physical space. Despite of these advanced features, average consumers prefer more functions on those high performance portable computers.

In the past, there are many inventions are granted for the portable computer having a detachable or non-detachable display system. However, none of these patents are related to this invention. Furthermore, true values for those inventions are not passed onto consumers due to the luck of true usable devices.

Further, the technology of cellular telephone has been changing our life style in the past 10 years or so, and it will continue to increase the use of cellular telephone devices in the future.

Recently, new cellular telephones have been introduced. These cellular telephones have camera mounted on the cellular telephones. Callers can take pictures and send them to multimedia cellular telephone receivers though some manufactures do not allow swapping pictures among telephone users at all. In any case, this new technology is yet to change our life style to take pictures. However, currently available camera-mounted cellular telephones can not send images with caller's voice attached. It is nice to send images with recorded voice to senders to view images and listen to caller's voice. However, there is no camera-mounted cellular telephone with sound recording or playback capability.

Furthermore, pictures taken by these camera-mounted cellular telephones are too small to view. The digital camera technology is available to take large digital image size, and the same technology can be applied to these camera-mounted cellular telephones. The problem is on the receiver side. Once these large images with sound-recorded attached are sent, then a new viewing device is required to view these files since there is no such cellular telephone is available currently. Furthermore, the viewing size on the most of current cellular telephone is too small to view images received, and there is no sound-generating mechanism on these camera-mounted cellular telephones.

Objects and Advantages

Accordingly, besides the objects and advantages of the detachable and non-detachable display systems or any plasma or liquid crystal display (LCD) type display systems described in this patent, several objects and advantages of the present inventions are:

(a) to provide a method to display television-broadcasting programs using detachable or non-detachable AMLCD or LCD unit at any place;

(b) to provide a method to display a plurality of Cellular Internet web contents when used with an Internet browser capability cellular telephone;

(c) to provide a method to display music video that a digital radio station broadcasts digital audio and video signals so that a user can listen and watch video music;

(d) to provide a method to watch television, and listen radio while a user works on a portable computer at any place and any time;

(e) to provide a digital camera and sound recording or playback function in a cellular telephone;

(f) to provide a file storage system for images and sound-recorded files in the camera-mounted cellular telephone;

(g) to provide a sending function in a camera-mounted cellular telephone to send the image files and the sound-recorded files to another and same cellular telephone users, and to the multimedia receiver system together;

(h) to provide a receiving function in a camera-mounted cellular telephone to receive the image files and the sound-recorded files together; and

(i) to provide an interface connector to pass image files, sound-recorded files, and data files to the multimedia receiver display system.

These and further objects and advantages will be apparent to those skilled in the art in conjunction with drawings and the detailed description of the preferred embodiment set from below.

### SUMMARY OF THE INVENTION

An AMLCD or LCD unit of a portable computer is attached to the main body using mechanical hinges. To use the portable computer, a user opens the display system by unlatching it from the main body. Then, the user operates word processing software or browses Internet using dial-up telephone line or local area network after the power is turned on and the operating system is started.

The display system is one of the expensive components in its portable computer. Though prices of portable computers are coming down dramatically. However, consumers are not getting enough benefit using such expensive portable computers. The purpose of this invention is to increase the benefit and spread high cost component to wider capability scope so that consumers can take advantage of buying one portable computer with a small feature for the big advantages and features. One way to achieve this is to use it as a multi-function display system. Lately, sales of high definition television (HDTV) and digital television (DTV) have been risen at many electronic stores. However, since the cost of making huge plasma display system is so high, and consequently, implementing and adapting HDTV program into consumer are hampered. On the other hand, display systems of portable computers are getting less cost to produce since millions of units are manufactured in each year. Hence, this invention can take advantage of such trend by using a display system of the portable computer as entertainment display device. This is achievable by displaying multimedia information, such as video or music video with audio, and uses it as a screen like-television set. Hence, using the display system as the television monitor and other monitoring devices will enhance, and return the economical benefit to consumers.

Another advantage using a removed display system is to use as monitoring device for an Internet browser capable cellular telephone. Lately, much more advanced features in cellular telephones are equipped, and provided by many of cellular telephone manufactures such as web browsing capability and E-mail application. By connecting the display systems with these cellular telephones can browse Internet very easily rather than using small LCD screens currently used in all cellular telephones.

Another advantage is to use a newly invented camera-mounted and the sound recording or playback cellular telephone in conjunction with the multimedia system. Once, large digital images are taken by the camera-mounted cellular telephone, then the caller can record his/her sound associated for each image picture into that camera-mounted cellular telephone and store inside the camera-mounted cellular telephone for sending these images and sound files together to the multimedia system later.

Another advantage is to connect the camera-mounted with sound recording or playback function cellular telephone to the multimedia receiver system using a connector mounted on it so that large image files, sound-recorded files, and data files are transferred and generated on the multimedia display system.

Yet, another advantage using the multimedia receiver and cellular telephone system with any stand alone plasma or LCD display systems, that are available at any electronic stores, is to be able to display large images and regenerate the recorded sound sent by the newly invented camera-mounted and the sound recording or playback function cellular telephone.

Yet, another advantage is to use it for a digital radio receiver. Today's modern digital radio broadcasting stations can transmit digital music and video picture. Viewers can watch the music video and listen to the music, as many consumers view music videos on their televisions by using this multimedia system.

Another advantage is to use it together with a digital video display (DVD) player since the connector on this display system has the standard signal interface used in the video industry.

These ideas above mentioned are just few good and beneficial to consumers who are thinking of buying the newly implemented and designed portable computers. Buying the portable computer with this newly invented function will justify the buying cost because consumers don't need to buy both a TV set and a portable computer at the same time. Furthermore, when broadcasting companies are ready to broadcast HDTV fully, this newly invented detachable or non-detachable display system can use as HDTV monitor, which is different from the conventional analog television monitor.

### BRIEF DESCRIPTION OF FIGURES

FIG. 1 illustrates the diagram of the detached display system connected with the multimedia receiver system for television, radio, multimedia cellular telephone system, and satellite systems.

FIG. 2 illustrates the detail functional diagram of the multimedia receiver system.

FIG. 3 illustrates the diagram how the detachable multimedia display system and the multimedia receiver system connect with the television and radio stations, and the satellite station.

FIG. 4 illustrates the diagram how the detachable multimedia display system and the receiver connect with the multimedia cellular telephone system.

FIG. 5 illustrates a method how a conventional multimedia portable computer system with non-detachable multimedia display system connects to the receiver for receiving signals transmitted by the television, the radio, and the satellite stations.

FIG. 6 illustrates a toggle circuitry using a plurality of multiplexer integrated chips used in this newly invented multimedia portable computer system with non-detachable multimedia display system.

FIG. 7 illustrates the multimedia camera-mounted with sound recording or playback function cellular telephone system connected to the multimedia receiver system, a stand alone plasma or LCD multimedia display system, and World Wide Web (WWW) via Internet Service Provider.

FIG. 8 illustrates the multimedia camera-mounted with sound recording or playback function cellular telephone system connected to cellular telephone base station, Internet Service Provider, and WWW.

FIG. 9 illustrates a flowchart operation for the multimedia camera-mounted with sound recording or playback function cellular telephone system.

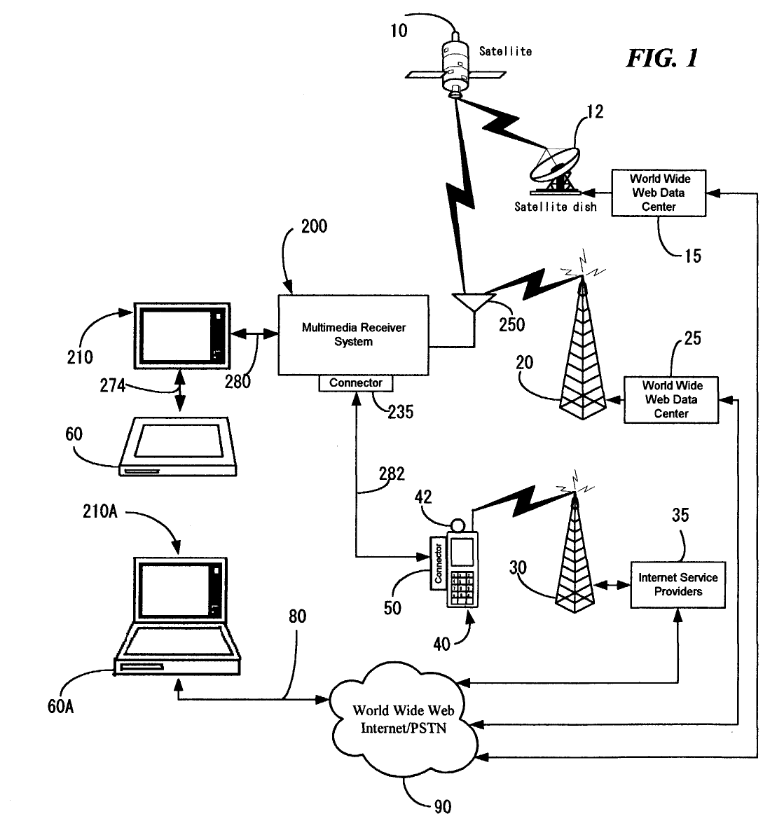

### DETAILED DESCRIPTION OF THE PREFERRED EMBODIMENT—FIGS. 1 TO 8

FIG. 1 illustrates how this newly invented detachable display system 210 is connected with a newly invented receiver 200.

A conventional portable computer has a main body and a display system. A plurality of cable connects the main body and the display system internally. Normally, users do not see these cables since they are housed in between the display system and the main body internally, which is the advantage of the portable computer. Having such mechanism and flexible cables enable to close the display system when the portable computer is not used.

For using the detachable display system 210, after it is detached from the main body of the portable computer 60 by disconnecting the internal cable 274 and the mechanical hinges, the display system 210 connects to the receiver 200. There is a signal cable 280, which connects the display system 210 and the receiver 200. The receiver 200 can receive signals from a satellite station 10, television or radio tower stations 20, and a cellular telephone transmission tower 30 by having an appropriate antenna type 250 for each station. Then the receiver 200 processes the signals transmitted by these stations and sends to the display system 210. The detached display system 210 works as the independent display system for the television, the music video, and the radio programs, and viewers can watch the programs at any places.

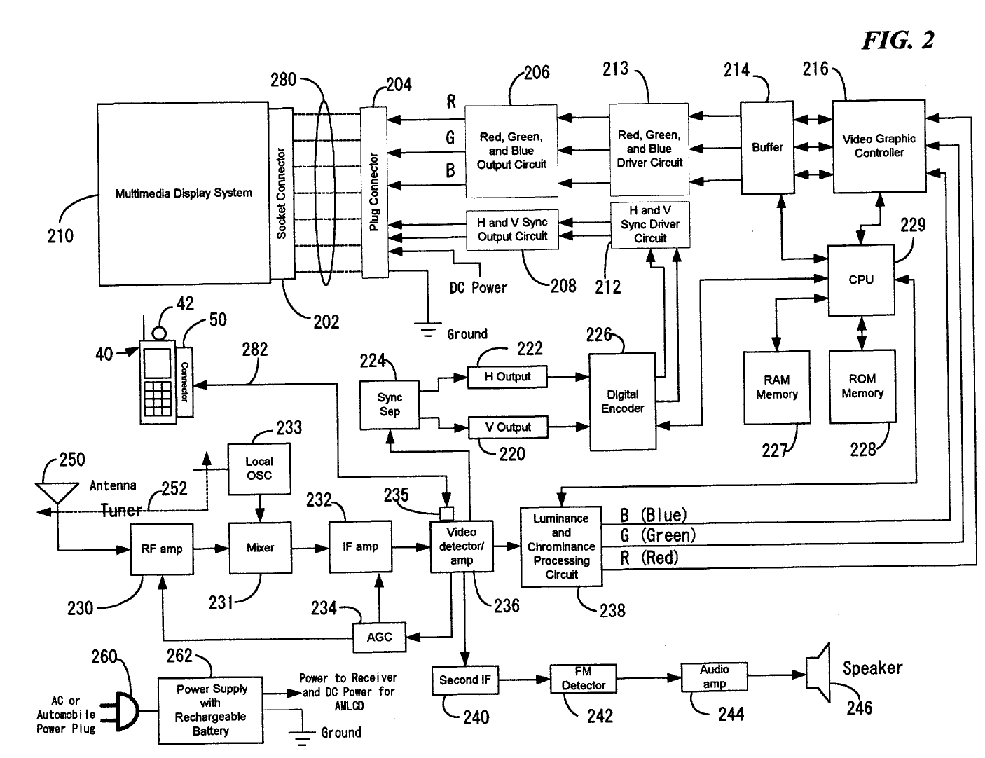

The conventional portable computer 60 connects to the Internet 90 to check broadcasting programs at each station's World Wide Web data center 15 and 25 by either dial-up or leased telephone line. Once a user finds favorite programs in the data center 15 or 25 that the user wants to see, then turn off the conventional portable computer 60. Then, the user disconnects the display system 210 from the main body of the portable computer 60, and connects it to the receiver 200. Viewing and selection of preferred programs transmitted by a broadcast station is achieved by adjusting the channel selector, which is the integral part of local oscillator 233 and the dashed arrow line 252 in FIG. 2.

The multimedia display system 210 can work with the multimedia camera-mounted with sound recording or playback function cellular telephone system 40, which has Internet browse capability. Instead of using a small LCD on the device 40, a telephone user can browse Internet using the display system 210 and the receiver 200 by using an external signal cable 282. Once it is connected then the user browses the Internet 90 by using keypads on the multimedia camera-mounted with sound recording or playback function cellular telephone system 40 just as the user normally does using the LCD display of the multimedia camera-mounted with sound recording or playback function cellular telephone system 40. Instead of having web contents displayed on the LCD, the web contents are displayed on the display system 210.

FIG. 2 illustrates detail functional diagram about a receiver 200. This is a typical superhetrodyne receiver block diagram. There are two input signal interfaces, and one output signal interface.

The first input signal, which consists of audio and video signals, is fed through an antenna 250 to a RF amp 230. The antenna 250 will have different types depending on signal sources from a home television antenna to a satellite dish antenna. The RF amp 230 and the tuner 252, which are the integral part of the local oscillator 233 and the dashed arrow line in FIG. 2, select broadcasting stations that viewers want to watch.

The second input signal for a cellar telephone signal is fed to a video detector/amplifier 236 via an external connector 235. A signal cable 282 connects the multimedia camera-mounted with sound recording or playback function cellular telephone system 40 and the receiver 200 using the external connectors 50 and 235. The signal from the multimedia camera-mounted with sound recording or playback function cellular telephone system 40 is non-modulated signal, and it is not required to go through the RF 230 and an IF ampr 232.

Since the multimedia camera-mounted with sound recording or playback function cellular telephone system 40 does not have full graphic display capability due to the physical size limitation of the LCD, an embedded browser software, such as Netscape or Microsoft Internet Explore software stored in a plurality of the ROM memory 228, can provide such capability. When the receiver 200 receives the full web contents via the multimedia camera-mounted with sound recording or playback function cellular telephone system 40, the CPU 229 detects web contents. If some applications are to be run on the receiver 200 such as Java application, then a CPU 229 can run Java application software, and so on.

Preferred channels defined by Federal Communication Commission (FCC) for both audio and video signal are selected by tuning right frequency of the local oscillator 233 and the tuner 252. The tuner 252 tunes a correct frequency with incoming frequency signals from the antenna 250 and the local oscillator 233 to detect a right career frequency for the broadcasting station.

The video detector/amplifier 236 separates the received signals into a plurality of audio, synchronization, and video signals. The audio signal is fed to a second intermediate frequency (IF) 240 and then fed to a frequency modulation (FM) detector 242 to detect sound. Once small sound signal is detected then it is amplified using an audio amp 244, which feeds to a speaker 246 to generate audio sound.

When the synchronization signal is processed using a sync separator 224, the output result will have two signals. One for horizontal (H) and the other is a vertical (V) sync signal. These signals are used together with the video signal to form correct pictures on the display system 210. Since these signals are analog, they need to be converted for the AMLCD display system 210. A digital encoder 226 does this process.

A video detector/amplifier 236 feeds the video signals to a plurality of luminance and chrominance processing circuitry 238. The luminance and chrominance circuitry 238 generates red, green, and blue signals, which are fed to a video graphic controller circuitry 216, and processed for the display system 210.

The video graphic controller 216, a plurality of buffer 214, a plurality of red, green, and blue driver 213, and its output circuitry 206 are standard output video driver circuitry used for any digital display systems, and are used in all personal computer graphic display cards.

A power supply 262 supplies power to the display system 210 and the receiver 200 through the second connector 202 and the plug connector 204. The display system 210 requires several DC voltages to drive a plurality of pixels, a plurality of field effect transistors (FET), and other passive components. The power source is supplied normally by the portable computer 60. Since the display system 210 is disconnected from the main unit of the portable computer 60, it requires separate power source to turn on the display system 210. A plug 260 can connect to AC or automobile power source.

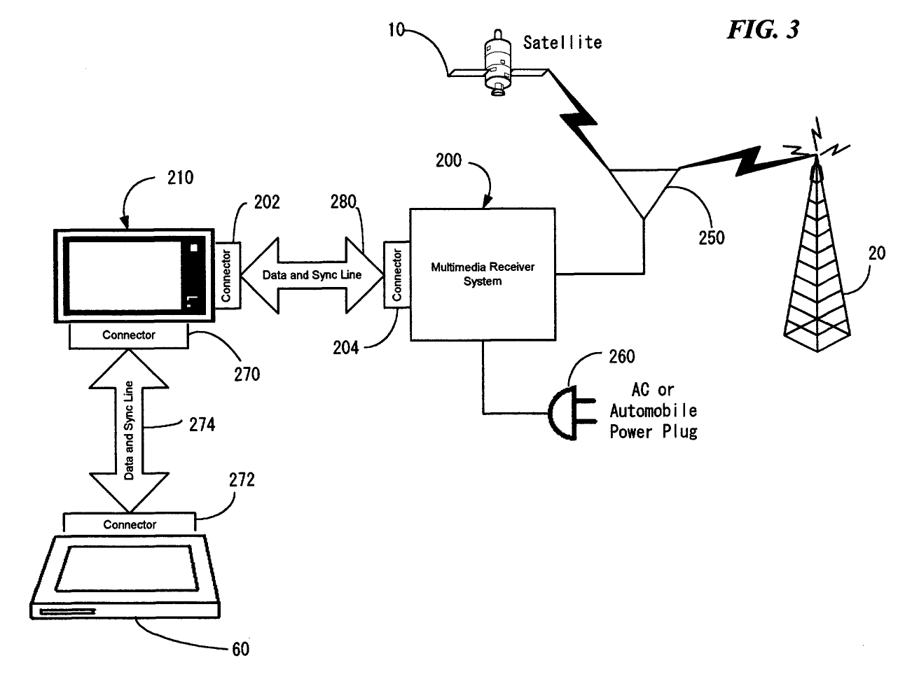

FIG. 3 illustrates a method of receiving signals from the satellite 10, and the radio and the television broadcasting stations 20 using the detached display system 210 and the receiver 200. The display system 210 is removed from the first connector 270, which mates to the connector 272 before it is removed. The signal 274 is transferred between the display system 210 and the main unit 60 when the display system 210 is connected with the main body 60 while the computer 60 is in operation. A different antenna 250 is required depending on types of signal sources. For receiving satellite broadcasting, a satellite dish antenna is used for the receiver 200 whereas for audio and television broadcastings, a regular indoor television antenna can be used.

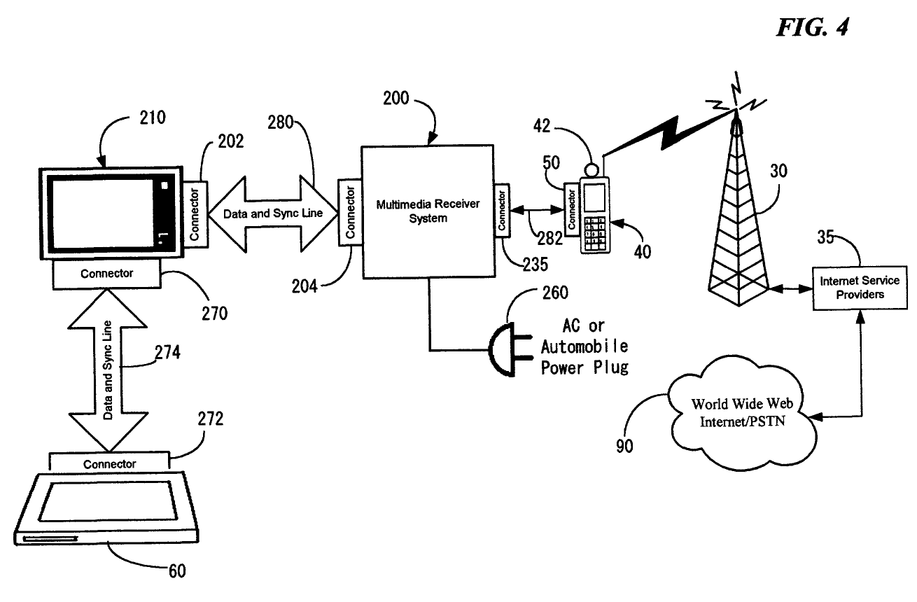

FIG. 4 illustrates a method of obtaining Internet web contents information using the multimedia camera-mounted with sound recording or playback function cellular telephone system 40 and the receiver 200. The current method to browse the Internet 90, provided by an Internet service provider (ISP) 35, is to use number keypads of the multimedia camera-mounted with sound recording or playback function cellular telephone system 40. Displaying graphical information on the multimedia camera-mounted with sound recording or playback function cellular telephone system 40 is limited by the physical size of the cellular telephone. Having and connecting the display system 210 to the multimedia camera-mounted with sound recording or playback function cellular telephone system 40 enables the browsing capability. Furthermore, since the display system 210 is detached from the main CPU unit, the separate power source is required.

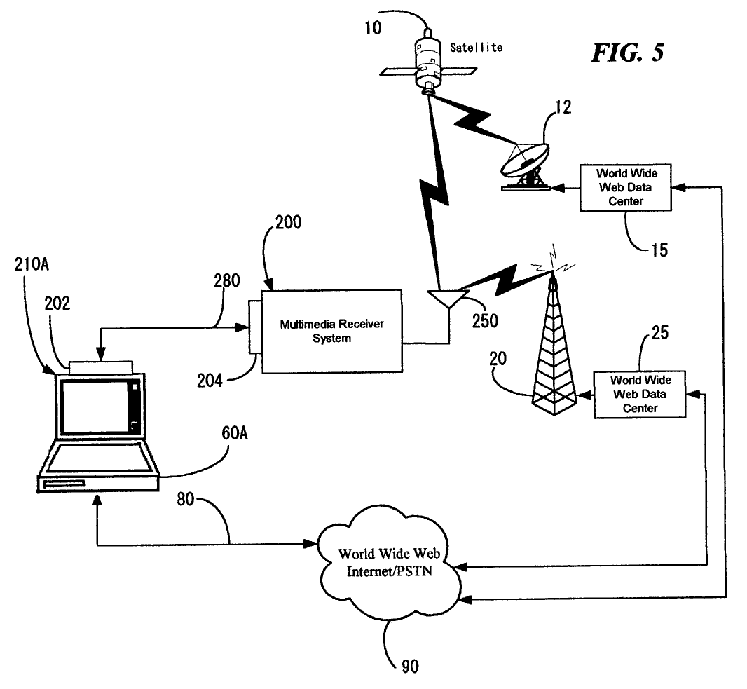

FIG. 5 illustrates how the conventional portable computer 60 is connected with the receiver 200 while a user uses the portable computer 60A. Without detaching the display system 210A of the conventional portable computer or turning off the power of the portable computer 60A, the receiver 200 can plug right into the second connector 202, in FIG. 2, of the display system 210A of the portable computer 60A. The user can watch television or listen to radio while the operation of the compute work is uninterrupted by toggling predefined keys of the portable computer 60A.

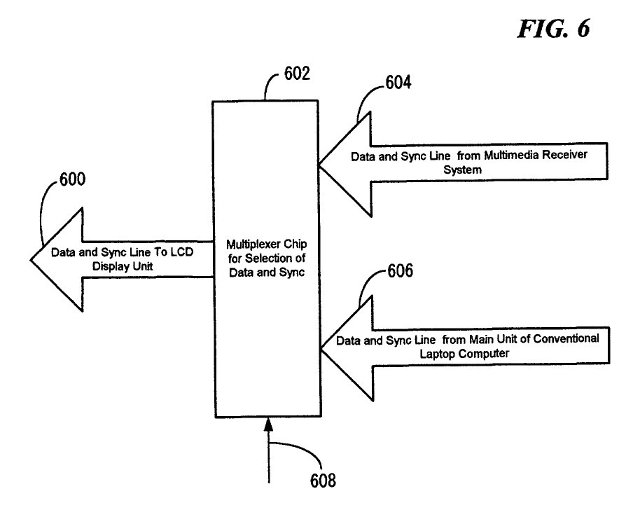

FIG. 6 illustrates an internal switching circuitry used when the receiver 200 and the conventional portable computer 60 connected, depicted in FIG. 5. The multiplex chip 602 receives a plurality of signals 604 and 606 from the receiver 200 and the main unit of the conventional portable computer 60 respectively. By combining couple of keys and pressing them enables the command line 608. The command depending which signal is present on the data and sync line 600 toggles the signal between the receiver 200 and the main unit of the portable computer 60.

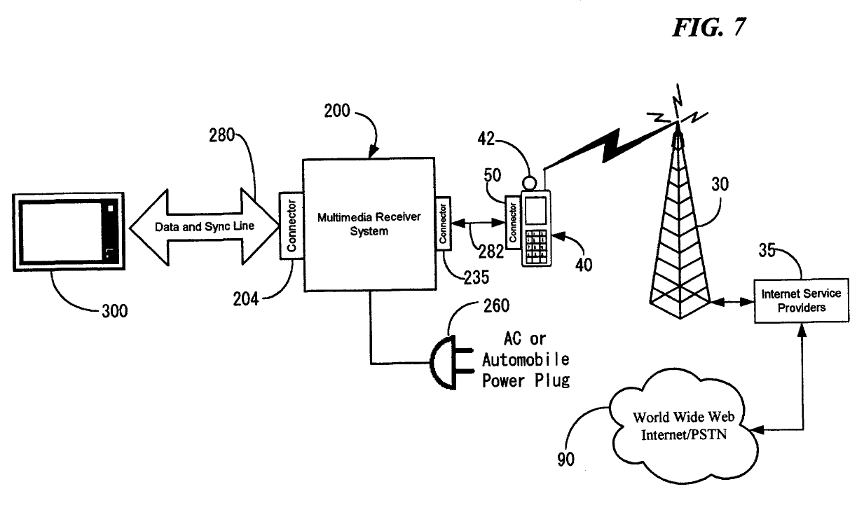

FIG. 7 illustrates the multimedia camera-mounted with sound recording or playback function cellular telephone system 40 connected to the multimedia receiver system 200, and the cellular telephone base station 30. The multimedia receiver system 200 connects to a stand alone plasma or LCD display system 300. The data and sync line 280 connects between the multimedia receiver system 200 and the stand alone plasma or LCD display system 300. When images with associated sound-recorded files are received by the multimedia camera-mounted with sound recording or playback function cellular telephone system 40, the multimedia receiver system 200 automatically recognize these files since the web server software is running all the time. When large images and recorded sound files are received by the multimedia camera-mounted with sound recording or playback function cellular telephone system 40, it cannot process these files since the display of the multimedia camera-mounted with sound recording or playback function cellular telephone system 40 is too small. By connecting the multimedia camera-mounted with sound recording or playback function cellular telephone system 40 to the multimedia receiver system 200, the images and the recorded sounds are processed by the multimedia receiver system 200, and its output is displayed on the multimedia plasma or LCD display system 300.

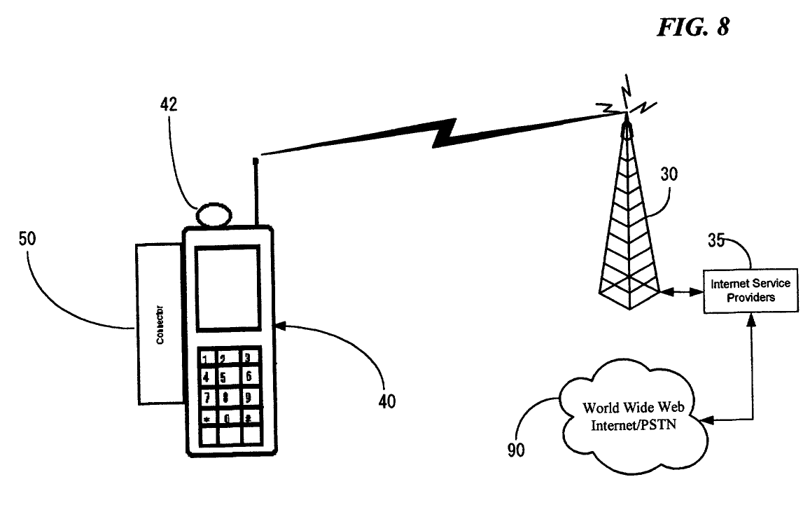

FIG. 8 illustrates the multimedia camera-mounted with sound recording or playback function cellular telephone system 40 connects to the cellular telephone base station 30, which also is also connected to Internet Service Provider 35 via the landline telephone line from the cellular telephone base station 30. The multimedia camera-mounted with sound recording or playback function cellular telephone system 40 can take any size images using the camera 42 mounted on the cellular telephone 40. While a caller takes a image by using the camera 42, the caller can also record any sound associated with that image using a built-in microphone and would be stored in the multimedia camera-mounted with sound recording or playback function cellular telephone system 40. Once, images are stored then the caller can send these images and sound files to the multimedia camera-mounted with sound recording or playback function cellular telephone system 40, which in turn, connects to the multimedia receiver system 200, whereby these images and recorded sound are re-generated.

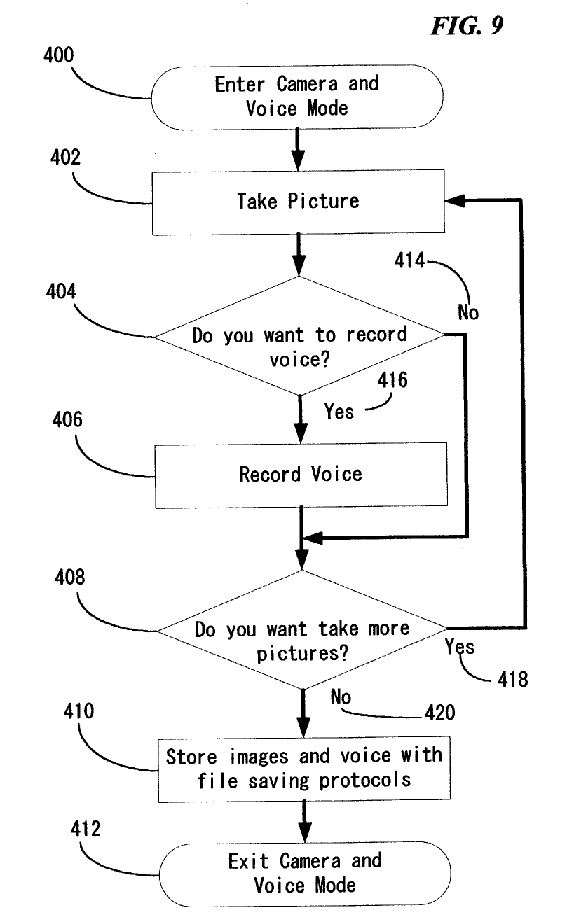

FIG. 9 illustrates a flowchart how to take images and record sound for each image taken by the multimedia camera-mounted with sound recording or playback function cellular telephone system 40. First, a user switches normal telephone mode to camera and sound ready mode 400. Then the camera 42 is ready to take images. When each image is taken then the multimedia camera-mounted with sound recording or playback function cellular telephone system 40 asks the question 404 whether the user want to take more images or not. When the user selects “Yes” 416 then the user is ready to record his/her sound by using a microphone of the multimedia camera-mounted with sound recording or playback function cellular telephone system 40. If “No” 414 is selected then the user is asked the question 408 to take more picture or not. However, once the sound is recorded then the multimedia camera-mounted with sound recording or playback function cellular telephone system 40 asks another question 408 whether the user wants to take more pictures or not. If the user selects “No” 420 then, the multimedia camera-mounted with sound recording or playback function cellular telephone system 40 saves all files using file saving protocol and exits the camera and sound mode 412. If the user selects “Yes” 418 then, the user can take more picture and record sound using the camera-mounted with sound recording or playback function cellular telephone system 40.

Operation—FIGS. 3, 4, 6, 8

For using the conventional portable computer 60 with a detachable unit 210 is as follows: to watch desired programs of television or music video programs, first a user connects to the Internet 90 by using either dial-up or a digitally subscribed line (DSL) line to browse desired program, and its time schedule at each broadcast station. Once, all information is obtained using the Internet 90 then turn off the power of the main portable computer 60. Then the user disconnects the display system 210 from a main unit of the portable computer 60. Once the display system 210 is disconnected then connect the display system 210 to a receiver 200 with a signal cable 280. Then select a desired channel by adjusting a tuner 252 of the receiver 200. Since the display monitor 210 and the receiver 200 are easily transportable, the user can see selected programs at any locations such as in a car, airplane, or any place in a house by just carrying the display system 210 and the receiver 200.

To browse the Internet 90 using the multimedia camera-mounted with sound recording or playback function cellular telephone system 40, instead of connecting a satellite dish antenna or a regular indoor television antenna 250, simply a user needs to connect the signal cable 282 from the multimedia cellular telephone system to the receiver 200 after ISP 35 is connected using regular web browser operation. At this moment, all web contents are viewed on the multimedia cellular telephone system. Hence, by connecting the multimedia cellular telephone system 40 with the receiver 200, the user can see better graphic contents than ones on LCD display system of the multimedia cellular telephone system 40, and send E-mail using any word processor software available on Internet to another users.

For using the conventional portable computer with non-detachable multimedia display system is as follows: a user simply connects the signal line cable 280 in FIG. 5 to a second connector 202 while the power of the portable computer 60 is turned on. Installing the application software on the portable computer, these enables to select a plurality of key combinations and provides a selection command, when those selected keys are pressed. This selection command selects one of the signals from the conventional portable computer or signal from the receiver 200. Using a couple of selected keys with the preloaded software, the user now can toggle the display system which signal 604 or 606 can be shown.

For using the camera-mounted with sound recording or playback function cellular telephone 40, the multimedia receiver system 200, and stand alone plasma or LCD multimedia display system 300, a multimedia cellular telephone system caller takes any size images and record sound associated with each image. The camera-mounted with sound recording or playback function multimedia cellular telephone system 40 can store these images with sound-recorded files automatically. Then, the caller connects to another and the same type cellular telephone users then the caller can send those stored images and recorded sound files. Once the multimedia cellular telephone system receiver receives these files then the receiver connects the multimedia cellular telephone system 40 using the connector 50 to the multimedia receiver system 200 using the connector 235. Using the Internet Web browser software, the image and sound recording or playback files are re-generated. The images are displayed on the stand-alone plasma or LCD display system 300, and the sound is generated using the speaker 246, which it is depicted in FIG. 2, of the multimedia receiver system 200.

Conclusion, Ramifications, and Scoops

Accordingly, the reader will see following advantages:

it provides enhancement of viewing capability using together with the camera-mounted with sound recording or playback function cellular telephone since the viewing area of the display system of a conventional portable computer and any stand alone plasma or LCD display systems are larger than that of the multimedia cellular telephone system;

it provides enhancement of viewing capability since each image displayed is explained with live sound of senders;

it provides more functions on an inactive component of a conventional portable computer when it is not used. This advantage returns the benefit of having such expensive component to consumers by using it as television and music video viewing unit;

it provides easy set up of viewing locations since the display system and receiver system is portable. Viewers can set it up at any places; and it provides HDTV viewing capability when HDTV broadcast starts fully.

Although the description above contains many specifications, these should not be construed as limiting the scope of the invention but as merely providing illustrations of some of the presently preferred embodiments of this invention.

Further, the scope of the invention should be determined by the appended claims and their legal equivalents, rather than by the example given.

What is claimed is:

1. A multimedia system comprising:
(a) a multimedia cellular telephone system means a camera-mounted with sound recording or playback function cellular telephone,
wherein said camera-mounted with sound recording or playback function on said multimedia cellular telephone system means image and sound recording or playback function and taking images are operated at the same time by a plurality of cellular telephone users;
wherein said camera-mounted with sound recording or playback function on said multimedia cellular telephone system means having a camera mounted on said cellular telephones having capability to take a plurality of pictures;
wherein the sound recording function means recording a plurality of sound, which is attached with each image and stored in said multimedia cellular telephone system using a plurality of file saving protocols;
wherein the sound recording function means recording a plurality of sound, and stored in said multimedia cellular telephone system using a plurality of file saving protocols, and said recorded sound is played back; and
wherein said protocols means a plurality of the file saving and generating instructions for each images and recorded sound used in said cellular telephone and the multimedia receiver system.
(b) a multimedia display system means a plasma or LCD or flat panel or alike display system connects to said multimedia receiver system and said multimedia cellular telephone system, and
wherein said images and said recorded sound are re-generated by processing a plurality of data and sync signals in said multimedia receiver system means displaying images and generating recorded sound sent by said multimedia cellular telephone system by using said multimedia display system.
(c) a multimedia receiver system means a receiver system means having the reception circuit to receive a plurality of signals from a plurality of televisions, radios, satellites, and said multimedia camera-mounted with sound recording or playback function cellular telephone systems,
wherein said receiver system has a plurality of antenna for receiving signals from television, satellite, and radio stations means connecting satellite antenna for receiving satellite signal, television antenna for receiving television broadcasting signal, and radio antenna for receiving radio signal, and connecting said multimedia cellular telephone system to said receiver system;
wherein said signal means having video, audio, and data information;
wherein said receiver system is connected to said multimedia display system means connecting said receiver system to said display system using a plurality of signal cables and said connectors; and
wherein connecting said receiver system to said display system means displaying a plurality of video on said display system of said multimedia system, and generating a plurality of said audio sound using a speaker on said receiver system.

2. The multimedia system according to claim 1, in which said the multimedia camera-mounted with sound recording or playback function cellular telephone system further providing:
(a) a plurality of file storage means images taken and recorded sound by said cellular telephone system are stored into the file system using a plurality of file saving protocols in said cellular telephone,
wherein each image has associated sound attached, and said file saving protocols are also attached with said files; and
wherein said protocols means a plurality of the file saving and regenerating instructions for each image and recorded sound in said cellular telephone system and said multimedia receiver system.
(b) a plurality of sending function means said stored files are sent by said cellular telephone user using said cellular telephone to another said cellular telephones and to said multimedia receiver system,
(c) a plurality of receiving function means a plurality of stored files in the multimedia camera-mounted with sound recording or playback function cellular telephone system are received by another multimedia camera-mounted with sound recording or playback function cellular telephone system and by said multimedia receiver system, and
wherein the received images and sound are re-generated according to said protocols and said multimedia receiver system; and
wherein said protocol is stored in a plurality of read only memory of said multimedia receiver system.
(d) a plurality of connectors on said cellular telephone means to connect said multimedia cellular telephone system to said multimedia receiver system using a plurality of cables to send a plurality of saved image and recorded sound file signals from said multimedia cellular telephone system to said multimedia receiver system.

3. The multimedia system according to claim 1, in which said multimedia receiver system comprising:
(a) having a plurality of input circuitry to receive a plurality of signal transmitted by a plurality of television and radio stations, and satellite broadcasting stations,
wherein said input circuitry consists of a radio frequency amplifier, a local oscillator, a mixer, an intermediate frequency amplifier, and a video detector;
wherein said video detector means separating said transmitted signal into a plurality of video, audio, and synchronization signals; and
wherein said signal means having a plurality of video, audio, and data information.
(b) having a multimedia cellular telephone input circuitry to receive a plurality of signals transmitted by said cellular telephone stations,
wherein said cellular telephone input circuitry consists of a video connector, and a video detector;
wherein said multimedia cellular telephone means having camera and sound recording or generating functions;
wherein said signal means having a plurality of video, audio, and data information, said files, and said protocols; and
wherein said protocol means having a plurality of file saving and retrieving instructions provided by said cellular telephone.
(c) having a plurality of signal processing circuitry to process said transmitted signal means reformatting a plurality of said transmitted signal format to another signal format means processing said transmitted signal using a plurality of signal processing circuitry,
wherein said signal processing circuitry means using a plurality of luminance and chrominance processing circuitry.
(d) having a plurality of synchronization separator circuitry means processing a plurality of said transmitted signal into a plurality of synchronization signals,
wherein said processing synchronization signal means processing into horizontal and vertical signal format using synchronization separator and its output circuitry; and
wherein said synchronization separator circuitry means separating said signal into horizontal and vertical sync synchronization signals.
(e) having a plurality of digital converter circuitry to process said signals into a flat panel display system compatible signal format,
wherein said flat panel display system compatible signal format means having a plurality of digital signal formats converted by using said digital converter circuitry; and
wherein said digital converter circuitry means converting analog signal into digital signal by using an encoder, a central processing unit, a plurality of read-only and random access memory, a plurality of video graphic controller, and a plurality of buffers.
(f) having a plurality of output circuitry to process said signal means having output signals, which are signal compatible for said display system,
wherein said output signal means processing said signals to amplify using a plurality of drivers and sync output circuitry.
(g) having a connector means connecting a multimedia cellular telephone system to said video detector to obtain a plurality of video, audio, and data signals, and
(h) having a power circuitry means supplying a plurality of power to said receiver system and said display system,
wherein said power supply circuitry means converting alternate current power to direct current, and direct current to direct current to operate said receiver system and said display system, and further, consist of a battery charger circuit to charge a plurality of batteries.

4. A multimedia system comprising:
(a) a multimedia computer system means a portable computer having a keyboard, a liquid crystal display system, and a central processing unit,
wherein said display system having a plurality of first connectors and having a plurality of second connectors to connect a multimedia receiver system;
wherein said display system means plasma display or flat panel liquid crystal display or alike display system having signal receiving circuitry and screen display circuitry connected to said second connectors in said display system; and
wherein said display system means detachable means removing said display system from said central processing unit, and said detached display is connectable again using said first connector.
(b) a multimedia receiver system means a receiver system means having the reception circuit to receive a plurality of signals from a plurality of televisions, radios, satellites, and said multimedia camera-mounted with sound recording or playback function cellular telephone systems, and
wherein said receiver system has a plurality of antenna for receiving signals from television, satellite, and radio stations means connecting satellite antenna for receiving satellite signal, television antenna for receiving television broadcasting signal, and radio antenna for receiving radio signal, and connecting said cellular telephone to said receiver system;
wherein said signal means having video, audio, and data information;
wherein said receiver system is connected to said multimedia display system means connecting said receiver system to said detached multimedia display system using a plurality of signal cables and said second connector; and
wherein connecting said receiver system to said detached multimedia display system means displaying a plurality of video on said detached multimedia display system of said multimedia system, and generating a plurality of said audio sound using a speaker on said receiver system.
(c) a multimedia cellular telephone having a connector means connecting said cellular telephone to said receiver system by using a plurality of signal cable,
wherein said cellular telephone connecting to said multimedia receiver system means displaying a plurality of Internet contents on said detached multimedia display system of said multimedia system.

5. The multimedia system according to claim 4, in which said multimedia receiver system comprising:
(a) having a plurality of input circuitry to receive a plurality of signal transmitted by a plurality of television and radio stations, and satellite broadcasting stations,
wherein said input circuitry consists of a radio frequency amplifier, a local oscillator, a mixer, an intermediate frequency amplifier, and a video detector;
wherein said video detector means separating said transmitted signal into a plurality of video, audio, and synchronization signals; and
wherein said signal means having a plurality of video, audio, and data information.
(b) having a multimedia cellular telephone input circuitry to receive a plurality of signals transmitted by said cellular telephone stations,
wherein said cellular telephone input circuitry consists of a video connector, and a video detector;
wherein said multimedia cellular telephone means having camera and sound recording or generating functions;
wherein said signal means having a plurality of video, audio, and data information, said files, and said protocols; and
wherein said protocol means having a plurality of file saving and retrieving instructions provided by said cellular telephone.
(c) having a plurality of signal processing circuitry to process said transmitted signal means reformatting a plurality of said transmitted signal format to another signal format means processing said transmitted signal using a plurality of signal processing circuitry,
wherein said signal processing circuitry means using a plurality of luminance and chrominance processing circuitry.
(d) having a plurality of synchronization separator circuitry means processing a plurality of said transmitted signal into a plurality of synchronization signals,
wherein said processing synchronization signal means processing into horizontal and vertical signal format using synchronization separator and its output circuitry; and
wherein said synchronization separator circuitry means separating said signal into said horizontal and said vertical sync synchronization signals.
(e) having a plurality of digital converter circuitry to process said signals into a flat panel display system compatible signal format,
wherein said flat panel display system compatible signal format means having a plurality of digital signal formats converted by using said digital converter circuitry; and
wherein said digital converter circuitry means converting analog signal into digital signal by using an encoder, a central processing unit, a plurality of read-only and random access memory, a plurality of video graphic controller, and a plurality of buffers.
(f) having a plurality of output circuitry to process said signal means having output signals, which are signal compatible for said display system,
wherein said output signal means processing said signals to amplify using a plurality of drivers and sync output circuitry.
(g) having a connector means connecting a multimedia cellular telephone system to said video detector to obtain a plurality of video, audio, and data signals, and
(h) having a power circuitry means supplying a plurality of power to said receiver system and said display system,
wherein said power supply circuitry means converting alternate current power to direct current, and direct current to direct current to operate said receiver system and said display system, and further, consist of a battery charger circuit to charge a plurality of batteries.

6. A multimedia system according to claim 4, in which said multimedia cellular telephone further providing:
(a) said multimedia cellular telephone system means a camera-mounted with sound recording or playback function cellular telephone,
wherein said camera-mounted with sound recording or playback function on said multimedia cellular telephone system means image and sound recording or playback function and taking images are operated at the same time by a plurality of cellular telephone users;
wherein said camera-mounted with sound recording or playback function on said multimedia cellular telephone system means having a camera mounted on said cellular telephones having capability to take a plurality of pictures;
wherein the sound recording function means recording a plurality of sound, which is attached with each image and stored in said multimedia cellular telephone system using a plurality of file saving protocols;
wherein the sound recording function means recording a plurality of sound, and stored in said multimedia cellular telephone system using a plurality of file saving protocols, and said recorded sound is played back; and
wherein said protocols means a plurality of the file saving and generating instructions for each images and recorded sound used in said cellular telephone and the multimedia receiver system.
(b) a plurality of file storage means images taken and recorded sound by said cellular telephone system are stored into the file system using a plurality of file saving protocols in said cellular telephone,
wherein each image has associated sound attached, and said file saving protocols are also attached with said files; and
wherein said protocols means a plurality of the file saving and regenerating instructions for each image and recorded sound in said cellular telephone system and said multimedia receiver system.
(c) a plurality of sending function means said stored files are sent by a cellular telephone user using said cellular telephone to another said cellular telephones and to said multimedia receiver system,
(d) a plurality of receiving function means said stored files are received by said cellular telephone and by said multimedia receiver system, and
wherein the received images and sound are re-generated according to said protocols and said multimedia receiver system; and
wherein said protocol is stored in a plurality of read only memory of said multimedia receiver system.
(e) a plurality of connectors on said cellular telephone means to connect said multimedia cellular telephone system to said multimedia receiver system using a plurality of cables to send a plurality of saved image and recorded sound file signals from said multimedia cellular telephone system to said multimedia receiver system.

7. A multimedia system comprising:
(a) a multimedia computer system means the portable computer having a keyboard, a liquid crystal display system, and a central processing unit, and
wherein said display system having a plurality of connectors on said display system;
wherein said connector means to connect said display system to said multimedia receiver system;
wherein said display system means plasma display or flat panel liquid crystal display or alike display system having a plurality of signal receiving circuitry and screen display circuitry connected to said connector in said display system; and
wherein said portable computer means having a plurality of signal input circuitry to toggle to receive a plurality of signals transmitted either from said central processing unit or said receiver system.
(b) a multimedia receiver system means a receiver system means having the reception circuit to receive a plurality of signals from a plurality of televisions, radios, satellites, and said multimedia camera-mounted with sound recording or playback function cellular telephone systems, and
wherein said receiver system has a plurality of antenna for receiving signals from television, satellite, and radio stations means connecting satellite antenna for receiving satellite signal, television antenna for receiving television broadcasting signal, and radio antenna for receiving radio signal, and connecting said cellular telephone to said receiver system;
wherein said signal means having video, audio, and data information;
wherein said receiver system is connected to said multimedia display system means connecting said receiver system to said multimedia display system using a plurality of signal cables and said connectors; and
wherein connecting said receiver system to said display system means displaying a plurality of video on said display system, and generating a plurality of audio sound using a speaker on said receiver system.
(c) a multimedia cellular telephone having a connector means connecting said cellular telephone to said receiver system by using a plurality of signal cable,
wherein said cellular telephone connecting to said multimedia receiver system means displaying a plurality of Internet contents on said detached multimedia display system of said multimedia system.

8. The multimedia system means according to claim 7, in which said multimedia receiver system comprising:
(a) having a plurality of input circuitry to receive a plurality of signal transmitted by a plurality of television and radio stations, and satellite broadcasting stations,
wherein said input circuitry consists of a radio frequency amplifier, a local oscillator, a mixer, an intermediate frequency amplifier, and a video detector;
wherein said video detector means separating said transmitted signal into a plurality of video, audio, and synchronization signals; and
wherein said signal means having a plurality of video, audio, and data information.
(b) having a multimedia cellular telephone input circuitry to receive a plurality of signals transmitted by said cellular telephone stations,
wherein said cellular telephone input circuitry consists of a video connector, and a video detector;
wherein said multimedia cellular telephone means having camera and sound recording or generating functions;
wherein said signal means having a plurality of video, audio, and data information, said files, and said protocols; and
wherein said protocol means having a plurality of file saving and retrieving instructions provided by said cellular telephone.
(c) having a plurality of signal processing circuitry to process said transmitted signal means reformatting a plurality of said transmitted signal format to another signal format means processing said transmitted signal using a plurality of signal processing circuitry,
wherein said signal processing circuitry means using a plurality of luminance and chrominance processing circuitry.
(d) having a plurality of synchronization separator circuitry means processing a plurality of said transmitted signal into a plurality of synchronization signals,
wherein said processing synchronization signal means processing into horizontal and vertical signal format using synchronization separator and its output circuitry; and
wherein said synchronization separator circuitry means separating said signal into horizontal and vertical sync synchronization signals.
(e) having a plurality of digital converter circuitry to process said signals into a flat panel display system compatible signal format,
wherein said flat panel display system compatible signal format means having a plurality of digital signal formats converted by using said digital converter circuitry; and
wherein said digital converter circuitry means converting analog signal into digital signal by using an encoder, a central processing unit, a plurality of read-only and random access memory, a plurality of video graphic controller, and a plurality of buffers.
(f) having a plurality of output circuitry to process said signal means having output signals, which are signal compatible for said display system,
wherein said output signal means processing said signals to amplify using a plurality of drivers and sync output circuitry.
(g) having a connector means connecting a multimedia cellular telephone system to said video detector to obtain a plurality of video, audio, and data signals, and
(h) having a power circuitry means supplying a plurality of power to said receiver system and said display system,
wherein said power supply circuitry means converting alternate current power to direct current, and direct current to direct current to operate said receiver system and said display system, and further, consist of a battery charger circuit to charge a plurality of batteries.

9. The multimedia system according to claim 7, in which said portable multimedia computer system further providing:
(a) said portable computer having a keyboard, a liquid crystal display system, and a central processing unit, and
wherein said display system having a plurality of connectors on said display system;
wherein said connector means to connect said display system to said multimedia receiver system;
wherein said display system means plasma display or flat panel liquid crystal display or alike display system having a plurality of signal receiving circuitry and screen display circuitry connected to said connector in said display system; and
wherein said portable computer means having a plurality of signal input circuitry to toggle to receive a plurality of signals transmitted either from said central processing unit or said receiver system.
(b) said portable computer connecting to Internet means connecting said portable computer to Internet and accessing broadcasting station data center using said multimedia receiver system,
wherein accessing broadcasting data center means obtaining a plurality of broadcasting information, such as time, program names, and its broadcasting time length, for said television, and said radio programs.

10. The multimedia system according to claim 7, in which said multimedia cellular telephone system further providing:
(a) said multimedia cellular telephone system means a camera-mounted with sound recording or playback function cellular telephone,
wherein said camera-mounted with sound recording or playback function on said multimedia cellular telephone system means image and sound recording or playback function and taking images are operated at the same time by a plurality of cellular telephone users;
wherein said camera-mounted with sound recording or playback function on said multimedia cellular telephone system means having a camera mounted on said cellular telephones having capability to take a plurality of pictures;
wherein the sound recording function means recording a plurality of sound, which is attached with each image and stored in said multimedia cellular telephone system using a plurality of file saving protocols;
wherein the sound recording function means recording a plurality of sound, and stored in said multimedia cellular telephone system using a plurality of file saving protocols, and said recorded sound is played back; and
wherein said protocols means a plurality of the file saving instructions to store each image and recorded sound.
(b) a file storage means images taken and recorded sound by said cellular telephone system stored into the file system using a plurality of file saving protocols in said cellular telephone,
wherein each image has associated sound attached, and said file saving protocols are also attached with said files; and
wherein said protocols means a plurality of the file saving and regenerating instructions for each image and recorded sound in said cellular telephone system and said multimedia receiver system.
(c) a plurality of sending function means said stored files are sent by a cellular telephone user using said cellular telephone to another said cellular telephones and to said multimedia receiver system,
(d) a plurality of receiving function means said stored files are received by said cellular telephone and by said multimedia receiver system, and
wherein the received images and sound are re-generated according to said protocols and said multimedia receiver system; and
wherein said protocol is stored in a plurality of read only memory of said multimedia receiver system.
(e) a plurality of connectors on said cellular telephone means to connect said multimedia cellular telephone system to said multimedia receiver system using a plurality of cables to send a plurality of saved image and recorded sound file signals from said multimedia cellular telephone system to said multimedia receiver system.

11. A multimedia cellular telephone system providing:
(a) said multimedia cellular telephone system means a camera-mounted with sound recording or playback function cellular telephone,
wherein said camera-mounted with sound recording or playback function on said multimedia cellular telephone system means image and sound recording or playback function and taking images are operated at the same time by a plurality of cellular telephone users;
wherein said camera-mounted with sound recording or playback function on said multimedia cellular telephone system means having a camera mounted on said cellular telephones having capability to take a plurality of pictures;
wherein the sound recording function means recording a plurality of sound, which is attached with each image and stored in said multimedia cellular telephone system using a plurality of file saving protocols;
wherein the sound recording function means recording a plurality of sound, and stored in said multimedia cellular telephone system using a plurality of file saving protocols, and said recorded sound is played back; and
wherein said protocols means a plurality of the file saving instructions to store each image and recorded sound.
(b) a file storage means images taken and recorded sound by said cellular telephone system stored into the file system using a plurality of file saving protocols in said cellular telephone,
wherein each image has associated sound attached, and said file saving protocols are also attached with said files; and
wherein said protocols means a plurality of the file saving and regenerating instructions for each image and recorded sound in said multimedia cellular telephone system and said multimedia receiver system.
(c) a plurality of sending function means said stored files are sent by a cellular telephone user using said cellular telephone to another said cellular telephones and to said multimedia receiver system,
(d) a plurality of receiving function means said stored files are received by said cellular telephone and by said multimedia receiver system, and
wherein the received images and sound are re-generated according to said protocols and said multimedia receiver system; and
wherein said protocol is stored in a plurality of read only memory of said multimedia receiver system.
(e) a plurality of connectors on said cellular telephone means to connect said multimedia cellular telephone system to said multimedia receiver system using a plurality of cables to send a plurality of saved image and recorded sound file signals from said multimedia cellular telephone system to said multimedia receiver system.

12. A multimedia receiver system comprising:
(a) having a plurality of input circuitry to receive a plurality of signal transmitted by a plurality of television and radio stations, and satellite broadcasting stations,
wherein said input circuitry consists of a radio frequency amplifier, a local oscillator, a mixer, an intermediate frequency amplifier, and a video detector;
wherein said video detector means separating said transmitted signal into a plurality of video, audio, and synchronization signals; and
wherein said signal means having a plurality of video, audio, and data information.
(b) having a multimedia cellular telephone input circuitry to receive a plurality of signals transmitted by said cellular telephone stations,
wherein said cellular telephone input circuitry consists of a video connector, and a video detector;
wherein said multimedia cellular telephone means having camera and sound recording or generating functions;
wherein said signal means having a plurality of video, audio, data information, files, and protocols; and
wherein said protocol means having a plurality of file saving and retrieving instructions provided by said cellular telephone.
(c) having a plurality of signal processing circuitry to process said transmitted signal means reformatting a plurality of said transmitted signal format to another signal format means processing said transmitted signal using a plurality of signal processing circuitry,
wherein said signal processing circuitry means using a plurality of luminance and chrominance processing circuitry.
(d) having a plurality of synchronization separator circuitry means processing a plurality of said transmitted signal into a plurality of synchronization signals,
wherein said processing synchronization signal means processing into horizontal and vertical signal format using synchronization separator and its output circuitry; and
wherein said synchronization separator circuitry means separating said signal into said horizontal and said vertical sync synchronization signals.
(e) having a plurality of digital converter circuitry to process said signals into a flat panel display system compatible signal format,
wherein said flat panel display system compatible signal format means having a plurality of digital signal formats converted by using said digital converter circuitry;
wherein said digital converter circuitry means converting analog signal into digital signal by using an encoder, a central processing unit, a plurality of read-only and random access memory, a plurality of video graphic controller, and a plurality of buffers; and
wherein said flat panel display system means having a plurality of independent and separate connectors to connect to said multimedia receiver system and to receive a plurality of video, audio, and data signals from said multimedia receiver system.
(f) having a plurality of output circuitry to process said signal means having output signals, which are signal compatible for said display system,
wherein said output signal means processing said signals to amplify using a plurality of drivers and sync output circuitry.
(g) having a connector means connecting said multimedia cellular telephone system to said video detector to obtain a plurality of video, audio, and data signals, and
(h) having a power circuitry means supplying a plurality of power to said receiver system and said display system,
wherein said power supply circuitry means converting alternate current power to direct current, and direct current to direct current to operate said receiver system and said display system, and further, consist of a battery charger circuit to charge a plurality of batteries.

13. A multimedia computer system providing:
(a) said portable computer having a keyboard, a liquid crystal display system, and a central processing unit, and
wherein said display system having a plurality of connectors on said display system;
wherein said connector means to connect said display system to said multimedia receiver system;
wherein said display system means plasma display or flat panel liquid crystal display or alike display system having a plurality of signal receiving circuitry and screen display circuitry connected to said connector in said display system; and
wherein said portable computer means having a plurality of signal input circuitry to toggle to receive a plurality of signals transmitted either from said central processing unit or said receiver system.
(b) said portable computer connecting to Internet means connecting said portable computer to Internet and accessing broadcasting station data center using said multimedia receiver system,
wherein accessing broadcasting data center means obtaining a plurality of broadcasting information, such as time, program names, and its broadcasting time length, for said television, and said radio programs.

14. A multimedia computer system comprising:
(a) said multimedia computer system means a portable computer having a keyboard, a liquid crystal display system, and a central processing unit,
wherein said display system having a plurality of first connectors and having a second connector to connect said multimedia receiver system;
wherein said first connector on said display system means having said first connector to connect said central processing unit;
wherein said display system means plasma display or flat panel liquid crystal display or alike display system having signal receiving circuitry and screen display circuitry connected to said second connector in said display system; and
wherein said display system means detachable means removing said display system from said central processing unit, and said detached display is connectable again using said first connector.
